(19) United States
(12) Patent Application Publication
(10) Pub. No.: US 2006/0224305 A1
(43) Pub. Date: Oct. 5, 2006

(54) Vehicle unit for controlling communications between a vehicle and a wireless device

(75) Inventors: Mohammed Ansari, San Diego, CA (US); Martin Fichter, San Diego, CA (US); Tejas Desai, Troy, MI (US); Bruce Wrenbeck, Farmington HIlls, MI (US); Lori Hess, Folsom, CA (US); Arthur Jin, San Diego, CA (US); Joseph Beaty, Southlake, TX (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO automotive Corporation, Auburn Hills, MI (US)

(21) Appl. No.: 11/396,372

(22) Filed: Mar. 31, 2006

Related U.S. Application Data
(60) Provisional application No. 60/667,471, filed on Apr. 1, 2005.
(60) Provisional application No. 60/667,468, filed on Apr. 1, 2005.
(60) Provisional application No. 60/667,469, filed on Apr. 1, 2005.
(60) Provisional application No. 60/667,470, filed on Apr. 1, 2005.
(60) Provisional application No. 60/667,472, filed on Apr. 1, 2005.

(51) Int. Cl. G01C 21/00

(52) U.S. Cl. 701/202; 701/2

(57) ABSTRACT

A vehicle includes a communication unit for communicating with a wireless device including a selection portion and a command portion. The selection portion provides an interface for a user to select functions of the vehicle for control by the wireless device. The command portion of the communication unit receives user input from the selection portion. The command portion includes a controller that accepts the user input from the selection portion and generates the wireless communications to the wireless device. The wireless communications enable the wireless device to communicate with the command portion, which then controls the desired vehicle function.

### REFERENCE TO RELATED APPLICATIONS

The application claims priority to U.S. Provisional Application Nos. 60/667,471, 60/667,468, 60/667,469, 60/667,470, and 60/667,472 all or which were filed on Apr. 1, 2005.

### BACKGROUND OF THE INVENTION

The present invention relates to communications involving a wireless device, more specifically, the present invention relates to a method of controlling communications between a wireless device and a vehicle.

Wireless devices are used for a variety of types of communications, such as telephone and Bluetooth communications. Wireless devices save time for a user (e.g., automatically unlocking vehicle doors) and increase convenience (e.g., heating a vehicle prior to entering). Carrying and maintaining a plurality of wireless devices reduces the time saving advantages associated with using wireless devices, because the often spends much time locating the appropriate wireless device to perform the desired function. Disadvantageously, time is wasted locating the appropriate wireless device, detracts from the purported benefits of the wireless device.

Incorporating additional content and features into existing wireless devices would prevent the need to locate specific devices for specific functions. Instead, one device would be responsible for a variety of functions.

Some users may individually program a particular wireless device, such as a Personal Data Assistant (PDA), to control certain vehicular functions. In so doing, the user increases the number of functions that one wireless device, for example the PDA, controls. In such a known example, the user may wirelessly communicate with a vehicle using the programmed PDA. Disadvantageously, the user must individually program the PDA to control the desired vehicle functions, and later changes to any parameters require the user to reprogram the PDA. Also, if the user desires to control the vehicle with additional wireless devices, the user must individually program each desired wireless device.

If the PDA controls a security function of the vehicle, such as locking the vehicle's doors, losing a programmed PDA presents a vehicle security risk. Because there is no mechanism for remotely erasing the programmed PDA, or for authenticating the programmed PDA prior to use, anyone possessing the programmed PDA could use the PDA to control the vehicle functions.

Wireless devices frequently include personal information about the user. In the event the user is involved in an accident, many of today's vehicles can communicate accident specific information about the vehicle to an emergency dispatch center or rescue crew, General Motors' OnStar System is one such example. However, this system does not provide for an immediate exchange of personal information to the rescue crew. Instead, the users involved in the accident typically verbally relays personal information to rescue crews upon their arrival at the accident scene, and, in the event the user is incapacitated, the rescue crew will not have personal information readily available. The vehicle may relay information relating to the owner or regular occupant of the vehicle; however, the vehicle has no way of recognizing an occupant and relaying information specific to that occupant.

Accordingly, it is desirable to program a wireless device utilizing a vehicle. It is also desirable to provide a wireless device capable of communicating with multiple vehicles and which has an increased level of security. It is further desirable to link a user's wireless device with a vehicle so information about both the vehicle and the user can be readily shared.

These and other features of the present invention can be best understood from the following specification and drawings, the following of which is a brief description.

### SUMMARY OF THE INVENTION

A vehicle includes a communication unit with a selection portion and a command portion. The unit is capable of wireless communications with a wireless device. The selection portion provides an interface for a user to select functions of the vehicle for control by the wireless device. The command portion of the communication unit receives user input from the selection portion. The command portion includes a controller that accepts the user input from the selection portion and generates the wireless communications to the wireless device. The wireless communications enable the wireless device to communicate with the command portion, which then controls the desired vehicle function.

In one example, the command portion accepts wireless communications from the wireless device, but only if that wireless device has been authenticated. In such an example, the user first selects a vehicle function for control and how that vehicle function will be initiated by the wireless device. The controller and the command portion then wirelessly communicates a programming signal to the wireless device programs the vehicle to recognize the communication from the wireless device. The controller also determines if the wireless communication is from an authenticated wireless device. After determining that an authenticated wireless device is transmitting a valid wireless command, the controller initiates the vehicle function. If the wireless device is not authenticated, the user must reprogram the vehicle function for control by the wireless device.

In one example, a user carries a Personal Data Assistant (PDA) equipped with a numerical keypad and a communicative antenna. The example PDA is capable of sending and receiving wireless communications. Programming the PDA to control the locking functions of the vehicle eliminates having to carry the factory-issued Keyless Entry Device.

Programming the PDA to control the locking function includes the steps of first selecting the locking function as the vehicle function that is desired to control. The selection process is executed within the vehicle, and is accomplished via a display screen or other communication device such as by keypad or voice command. After establishing the desired function, the command portion and associated controller relay commands to the PDA to enable wirelessly communication with the vehicle communication unit. Other wireless devices within range of the command portion may also receive the wireless communication. To provide a single wireless communication for programming multiple wireless devices

The communication unit of the vehicle wirelessly communicates information to the PDA if the vehicle is involved in an accident. In turn, the PDA transmits the accident related information to a central dispatch center. In addition to accident specific information, the PDA may also transmit personal information relating to those involved in the accident. Further, the PDA can transmit specific information relating to the vehicle, such as the date of last repair.

Accordingly, the method and devices according to this invention combine many vehicle control functions into a single wireless device while maintaining a desired level of security.

### BRIEF DESCRIPTION OF THE DRAWINGS

FIG. 1 is a schematic illustration of the communications between a communication unit and a wireless device.

FIG. 2 is a schematic flow chart of sample communications between the communication unit and a wireless device.

FIG. 3 is an illustration of an example wireless device.

FIG. 4 is an illustration of an example display.

### DETAILED DESCRIPTION OF THE PREFERRED EMBODIMENT

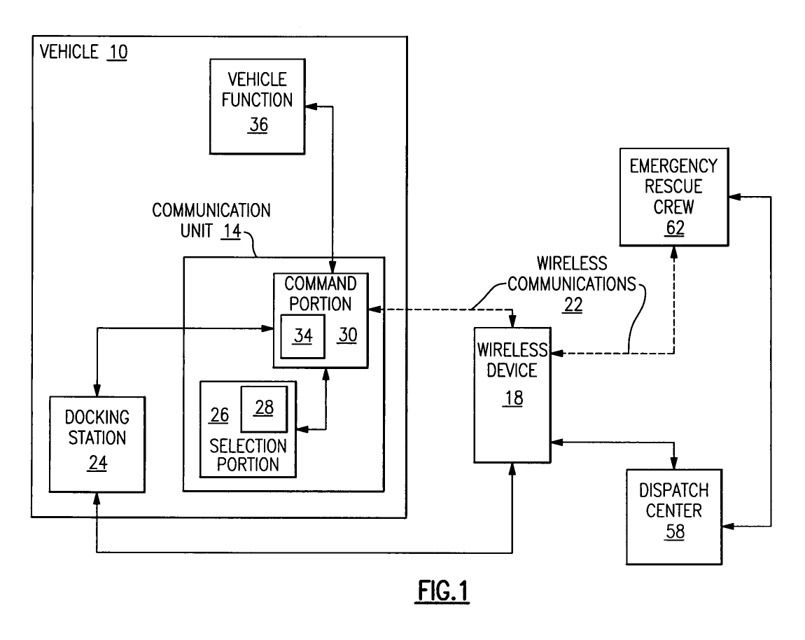

Referring to the schematic of FIG. 1, a vehicle 10 includes a communication unit 14 for communicating with a wireless device 18. The communication unit 14 and the wireless device 18 communicate using wireless communications 22, such as Bluetooth communications. The vehicle 10 also includes a docking station 24 for alternatively directly connecting the wireless device 18 to the communication unit 14. The docking station 24 is of a configuration directly compatible with the desired wireless device 18.

The term wireless device is utilized throughout the description of the example communication device. As should be appreciated, the term wireless device as utilized in this description refers to known devices including cellular phones, personal computers, laptop computers, personal digital assistances, Mps players, music and video display devices, along with variations and combinations of these examples. A specific wireless device may be discussed by way of example, but is no way meant to limit the configuration or type of wireless device that may utilized to practice the disclosed invention.

The communication unit 14 includes a selection portion 26 and a command portion 30. The selection portion 26 provides an interface for a user to select functions of the vehicle 10 desired to be controlled by the wireless device 18. In this example, the selection portion 26 provides an interface that is a selection menu on a display 28. The selection portion 26, and specifically the display 28, enables the user to select a vehicle function 36 for control.

The command portion 30 of the communication unit 14 receives user input from the selection portion 26. A controller 34, within the command portion 30, accepts the user input from the selection portion 26. The command portion 30 then transmits the wireless communications 22 to the wireless device 18 using a wireless transmitter or similar device. The wireless communications 22 enable the wireless device 18 to communicate with the command portion 30, which then controls the desired vehicle function 36.

The wireless device 18 and the command portion 30 of the vehicle 10 are capable of two-way communication utilizing the wireless communications 22, i.e., the wireless device 18 can send wireless communications 22 to the command portion 30 of the vehicle 10, just as the command portion 30 of the vehicle 10 can send wireless communications 22 to the wireless device 18.

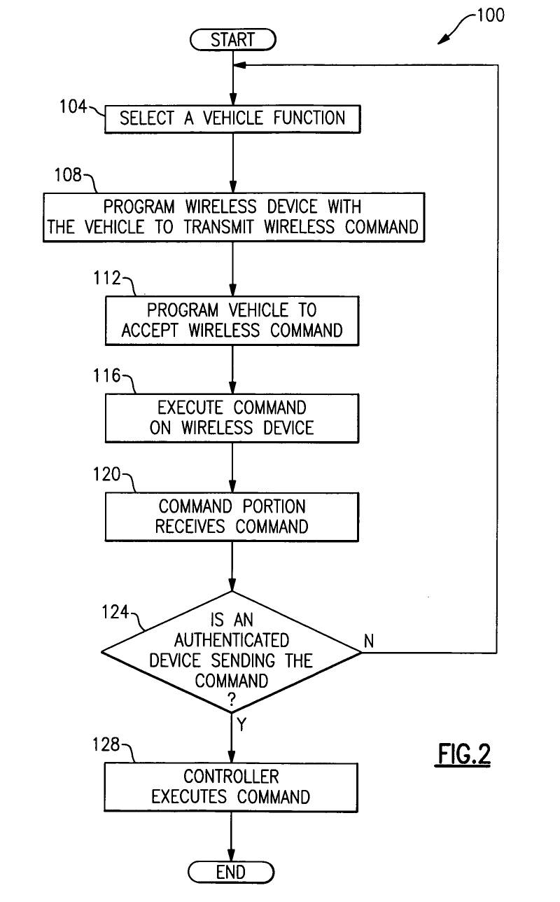

Referring now to the example method of FIG. 2 with continued reference to FIG. 1, the command portion 30 accepts a wireless communication 22 from the wireless device 18, but only if that wireless device 18 has been authenticated. In so doing, the example method 100 provides enhanced security.

The example method 100 begins as the user selects the vehicle function 36 that is desired to be controlled, as is indicated at block 104. The selection step 104 also includes the user selecting how to initiate the vehicle function 36 using the wireless device 18. For example, step block 104 requires the user to select a sequence of buttons on the wireless device 18, which, when actuated, send the associated wireless communication 22 to the command portion 30. Further, strength of the signal itself may provide the desired prompt to execute a desired command. For example, as the proximity of the wireless device 18 becomes closer to the vehicle, the signal strength from the wireless device 18 becomes stronger. Signal strength above a desired threshold value may cause activation of the desired function, such as opening or unlocking the vehicle doors.

After selecting the vehicle function 36 and how the vehicle function 36 will be initiated, the controller 34 and the command portion 30 wirelessly communicate an initial programming signal that programs the wireless device 18 for wireless communication 22 (step block 108) with the vehicle 10 (step block 112). In this way, any wireless device 18 within a wireless communication range of the command portion 30 may receive the wireless communication 22, and transmitting a single wireless communication 22 from the controller 34 may program multiple wireless devices 18. Alternatively, the wireless device 18 may also receive the initial programming signals when resting in the docking station 24.

The wireless device 18 and the vehicle 10 are in a linked communication within which the command portion 30 can receive and recognize wireless communications 22 from the wireless device 18. After establishing the linked communication between the wireless device 18 and the vehicle 10, the command portion 30 recognizes the wireless communication 22 from the wireless device 18.

As shown in step block 116, the command portion 30 receives wireless communications 22 from the wireless device 18 after the user initiates the wireless communication 22. Because the wireless device 18 and the command portion 30 are in linked communication, the controller 34 recognizes the wireless communication 22 from the wireless device 18 (step block 120). The controller 34 determines if the wireless communication 22 will control the desired vehicle function 36.

In this example, the controller 34 also determines if the wireless communication 22 is from an authenticated wireless device 18 (step block 124). Authentication may require the wireless device 18 to have wirelessly communicated with the communication unit 14 within a desired time, such as for example the last 48 hours. In so doing, security is enhanced because the user must reestablish the wireless communication 22 between the wireless device 18 and the vehicle after 48 hours with no wireless contact. If the user loses the wireless device 18, the user cannot control the vehicle function 36 unless the wireless device 18 has maintained wireless contact with the vehicle 10 within a desired time, for example every 48 hours. Further, the user, after losing the wireless device 18, can prohibit wireless device 18 control of the vehicle function 36 by reestablishing selections made in the selection portion 26 of the communication unit 14.

The user may bypass such an authentication requirement by reprogramming the command portion 30 and associated controller 34 using the selection portion 26 such that absence of wireless communication with the wireless device within the desired time does not disable control of vehicle functions by the wireless device 18. For instance, the user may disable the authentication requirement (step block 124) if the vehicle 10 is in long-term parking and is unable to authenticate with the wireless device 18. The user may also select an option that does not require any authentication of the wireless device 18.

After determining that an authenticated wireless device 18 is transmitting the wireless command 18, the controller 34 initiates the vehicle function 36 (step block 128). If the wireless device 18 is not an authenticated wireless device 18, the exemplary method requires the user to return to step block 104 whereupon the user must reselect the vehicle function 36 for control.

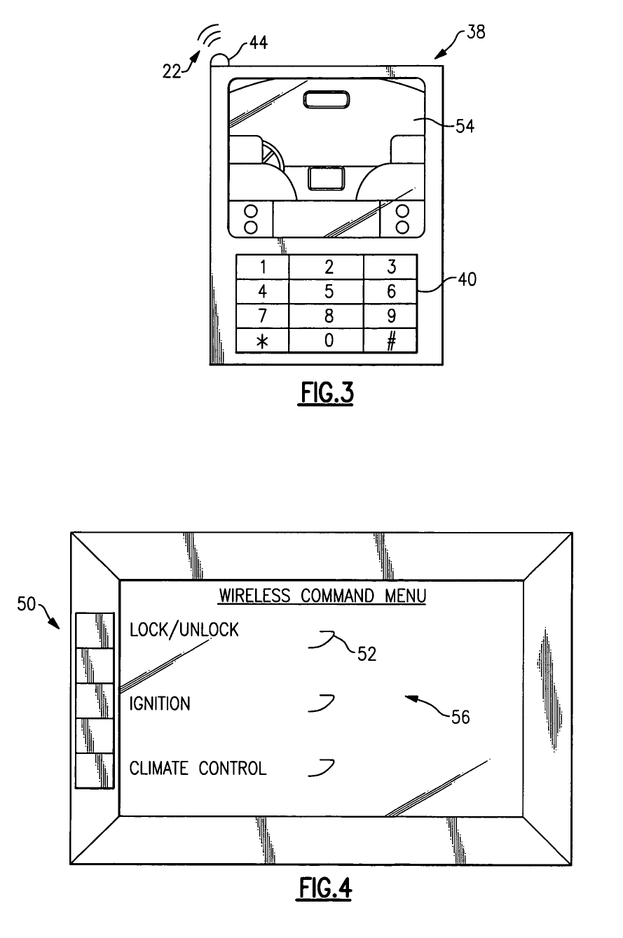

Referring now to FIG. 3 with continued reference to FIG. 1, the user may ordinarily carry a Personal Data Assistant (PDA) 38, equipped with a numerical keypad 40 and an antenna 44. The example PDA 38 is a type of wireless device 18 and is capable of sending and receiving wireless communications 22, such as for example Bluetooth communications. Because the user routinely carries the PDA 38, the user may want to control the locking and unlocking functions of the vehicle 10 using the PDA 38 instead of utilizing a factory-issued Keyless Entry Device. In so doing, the user will eliminate having to carry the factory-issued Keyless Entry Device and the user will only need to carry the PDA 38.

Prior to using the PDA 38 to control desired vehicle functions, the PDA must be linked (FIG. 2) to the vehicle 10. To establish the wireless link, the user interacts with the display 28. In addition to establishing the wireless link, the user may control other options, such as optionally programming another wireless device 18, in addition to the PDA 38. Additional selections for the user may also include prompting the user for how they want to utilize the PDA 38 to control the lock and unlock function. For instance, the user may determine that they would like to initiate locking or unlocking the vehicle 10 when the numbers 3-5-6 are sequentially pressed on the numerical keypad 40 of the PDA 38.

Alternatively, the PDA 38 may require no user input to the PDA 38 other than being within a range suitable for wireless communication 22 with the command portion 30. In such an example, the user may program the PDA 38 to adjust user specific vehicle functions 36 (e.g., seat settings, radio stations, steering wheel alignment) when the PDA 38 is capable of wireless communication 22 with the vehicle 10. Thus, when the user approaches the vehicle 10, the selected vehicle function 36 automatically adjusts to the settings established by the user utilizing the display 28.

Because the PDA 38 maintains wireless contact with the communication unit 14 of the vehicle 10, the PDA 38 can receive and display relevant information about the vehicle 10. In one example, the user may also remotely query the status of the vehicle 10 utilizing the PDA 38. The example vehicle 10 can include an interior camera, a type of vehicle function 36 that is controllable by the command portion 30 of the communication unit 14. The user, utilizing the interior camera, may observe the interior of the vehicle 10 by observing pictures or video on the wireless device 18. The PDA 38 includes a PDA display screen 54 and illustrates an example photograph of the interior of the vehicle 10.

Other parameters, such as vehicle alarm activation may also be monitored remotely using the PDA 38. Further, the PDA 38 may record items for recall at a later time. Example items for recall include recalling the position of the vehicle 10 when attempting to locate the vehicle 10 in a parking lot or recalling user specific settings within the vehicle 10 (e.g., seat settings, steering wheel alignment) and adjust to those settings when the wireless device 18 approaches the vehicle 10.

In addition, one PDA 38 may maintain control of the vehicle functions 36 for more than one vehicle 10, provided the additional vehicle 10 is equipped with the communication unit 14. Thus, a user possessing the PDA 38 may display information relating to more than one vehicle 10.

Referring to FIG. 1, the communication unit 14 of the vehicle 10 provides for wireless communication of information to the wireless device 18 if the vehicle 10 is involved in an accident. This information may include specifics of the accident, (e.g., vehicle model, airbag deployment, and vehicle speed), which the wireless device 18 then transmits to an appropriate receiving locations, such as a central dispatch center 58.

Although the vehicle 10 and the wireless device 18 typically communicate using a LF communication, other types of communication may be utilized. When outside of a range for wireless communication 22, the command portion 30 of the vehicle 10 and the wireless device 18 can communicate using telephone calls or by sending text messages. The user may establish a condition, that, when achieved causes the communication unit 14 to transmit a communication to the wireless device 18. In one example, the user programs the communication unit 14 to send a text message to the user's wireless device 18 if the interior temperature of the vehicle 10 rises above a predetermined level.

For example, if the wireless device 18 is a Short Message Service (SMS) enabled cellular phone, the wireless device may automatically relay a text message to the dispatch center 58 after the vehicle 10 is involved in the accident. Because the wireless device 18 is in wireless communication 22 with the vehicle communication unit 14, the text message may relay accident specific information to the dispatch center 58. The dispatch center 58 can then relay the accident specific information to an emergency rescue crew 62 enabling better preparation prior the arrival of the emergency rescue crew 62 on the accident scene.

In addition to accident specific information, various types of other vehicle information may be stored on the wireless device 18. For example, the wireless device 18 may also transmit personal information relating to those involved in the accident, such as the name, age, and blood type of the user. The communication unit 14 may also communicate other types of information, such as vehicle insurance information, vehicle registration information, and vehicle maintenance records. If the wireless device 18 is capable of audio recording, the wireless device 18 may record noises from the vehicle 10. If so desired, the noises can then be replayed for further review at a service station.

In addition, the example wireless device 18, wirelessly communicates (via Bluetooth) similar user specific information to the emergency crew 62 when the crew 62 is within wireless communication range. Thus, if the dispatch center 58 does not transmit the information to the emergency rescue crew 62, the information may still be wirelessly relayed to the emergency rescue crew 62.

The display 28 of the selection portion 26 may be a LCD display screen 50, as shown in FIG. 4. In addition to a lock/unlock function 52, the user may use the LCD display screen 50 to select from a vehicle function menu 56, which includes a listing of all vehicle functions 36 controllable by the wireless device 18 (FIG. 1). When not used as the display 28 of the selection portion 26, the example LCD display screen 50 can be used as a monitor for video programming or as a display for a navigation unit.

Although the display 28 is described in terms of the LCD display screen 50 that is installed in the vehicle 10, those persons skilled in the art and having the benefit of this disclosure will understand that the selection portion 26 may include interfaces other than the display 28, which are appropriate for providing a user interface. For example, the selection portion 26 may be controlled and accessed prior to the sale of the vehicle 10, such as at a dealership. In another example, the display 28 forms a portion of the wireless device 18 or a personal computer located remotely from the vehicle 10. Further, a voice recognition device may also be utilized to receive commands and sound verification of the desired selection.

Although a preferred embodiment of this invention has been disclosed, a worker of ordinary skill in this art might recognize that certain modifications are possible that come within the scope of this invention. For that reason, the following claims should be studied to determine the true scope of protection give for this invention.

What is claimed is:

1. A communication unit for providing control of a vehicle function by a wireless device, said communication unit, comprising:
a command portion for instructing a wireless device to control a vehicle function, and for establishing a wireless communication link between a communication unit and said wireless device; and
a selection portion enabling control of a vehicle function by said wireless device.

2. The communication unit of claim 1, wherein said command portion authenticates said wireless device.

3. The communication unit of claim 1, wherein said command portion is disposed in a vehicle.

4. The communication unit of claim 1, wherein said command portion transmits a wireless communication to establish said wireless communication link.

5. The communication unit of claim 1, wherein said command portion establishes said wireless communication link when said wireless device is docked in a docking station.

6. The communication unit of claim 1, including a controller for receiving a wireless command from said wireless device, and initiating said vehicle function.

7. The vehicle communication unit of claim 6, wherein said controller initiates said vehicle function in response to said wireless device entering a range suitable for wireless communication with said vehicle.

8. The vehicle communication unit of claim 6, wherein said controller initiates said vehicle function in response to a user actuating said wireless device.

9. The vehicle communication unit of claim 1, wherein said controller disables control of a desired vehicle function by the wireless device responsive to a failure to establish wireless contact within a desired time.

10. The vehicle communication unit of claim 1, wherein said wireless device controls adjustment of user specific vehicle functions.

11. The vehicle communications unit of claim 10, wherein the user specific vehicle functions comprises limiting vehicle speed responsive to receiving wireless communication from a desired wireless device.

12. A control unit for controlling a vehicle function, comprising:
a command portion disposed in a vehicle and capable of wireless communication with a wireless device;
a controller within said command portion for controlling a vehicle function; and
a selection interface enabling a user to select said vehicle function for control by said controller, wherein said selection interface is in communication with said controller, wherein said controller is operative to establish a wireless communication link between said command portion and said wireless device.

13. The control unit of claim 12, wherein said selection interface is disposed in said vehicle.

14. The control unit of claim 13, wherein said selection interface is a touch screen display.

15. The control unit of claim 13, wherein said selection interface receives voice commands.

16. A method of communicating using a wireless device, comprising:
a) sending a first wireless communication from a vehicle to a wireless device;
b) programming said wireless device to communicate with said vehicle using said first wireless communication;
c) sending a second wireless communication responsive to a desired event from said vehicle to said wireless device;
d) sending said second wireless communication from said wireless device to a receiving location responsive to a predefined event.

17. The method of claim 16, wherein the receiving location of step d) is a dispatch center.

18. The method of claim 16, wherein the receiving location of step d) is a second wireless device.

19. The method of claim 16, wherein said second wireless communication includes information about said vehicle.

20. The method of claim 16, including transmitting images from the vehicle to the wireless device.

21. The method of claim 16, including storing personal information on said wireless device.

22. The method of claim 16, wherein said second wireless communication includes said personal information.

23. A method of communication between a vehicle and a wireless device, comprising:
a) selecting a vehicle function controllable by a wireless device;
b) transmitting a signal from a vehicle to said wireless device; and
c) programming said wireless device to control said vehicle function using said signal.

24. The method of claim 23, wherein step b) includes transmitting a wireless signal.

25. The method of claim 24, wherein said wireless signal includes an image of some portion of the vehicle.

26. The method of claim 23, wherein step b) includes transmitting said signal by docking said wireless device to said vehicle.

27. The method of claim 23, including the step of:
d) displaying a menu of vehicle functions controllable by said wireless device.

28. The method of claim 27, wherein step d) includes using said vehicle to display said menu.

29. The method of claim 27, wherein step d) includes using said wireless device to display said vehicle.
